(19) United States
(12) Patent Application Publication
(10) Pub. No.: US 2020/0063311 A1
(43) Pub. Date: Feb. 27, 2020

(54) WOVEN CLOTH AND METHOD ABLE TO INTEGRALLY FORM A THREE-DIMENSIONAL PATTERN ON THE WOVEN CLOTH AND ITS FINISHED PRODUCT

(71) Applicants: Yang-Xun Hong, Taichung (TW); Xiu-Mei Lin, Taichung (TW)

(72) Inventors: Yang-Xun Hong, Taichung (TW); Xiu-Mei Lin, Taichung (TW)

(21) Appl. No.: 16/107,931

(22) Filed: Aug. 21, 2018

(51) Int. Cl. D06C 23/04; B29C 59/02; D01F 6/70; D02G 3/36; D06C 15/10

(52) U.S. Cl. CPC D06C 23/04; B29C 59/02; D01F 6/70; D10B 2403/033; D06C 15/10; D10B 2331/10; D02G 3/36

(57) ABSTRACT

A kind of woven cloth and a method able to integrally form a three-dimensional pattern on the woven cloth and its finished product in the present invention is to prepare a kind of woven cloth composed of lots yarns, and each yarn is made from several monofilaments, which respectively have an outer circumference coated with a thermoplastic polymer layer. After the woven cloth is hot pressed in a mold that is preformed with a three-dimensional pattern, the woven cloth will produce a corresponding three-dimensional pattern through compressing or hot melting of the thermoplastic polymer layer. Through above-mentioned method, the woven cloth can be integrally formed with a three-dimensional pattern, able to simplify manufacturing process, lower cost, increase strength and avoid disengaging and breaking apart of the woven cloth and able to be produced fully automatically.

### BACKGROUND OF THE INVENTION

### 1. Field of the Invention

This invention relates to woven cloth. particularly to a kind of woven cloth, and a method able to integrally form a three-dimensional pattern on the woven cloth and its finished product.

### 2. Description of the Prior Art

Generally, for enhancing effect of conspicuous decorative patterns on the fabric of clothes or shoes, ornaments will be combined on the fabric of clothes or shoes for matching. The ornament can be a pattern, a fastener, a logo or other fabric of same or different materials. At present, the method of combining the ornament with the fabric is mainly by machine sewing or sticking; therefore, the process of operation is complicated and it is necessary to consume much manpower, thus increasing manufacturing cost and not conform to economic gains. In addition, if the overlapping part of two pieces of fabric is jointed by sticking, the flexibility resistance is poor and, if the overlapping part is bent repeatedly, the two pieces of fabric are apt to disengage from each other or break apart, thus influencing quality of product.

In recent years, sports shoes market has developed a manufacturing method of woven shoes. For instance, the woven shoes ┌Flyknit┘ produced by the Nike company is woven with general yarns, and such woven shoes can use woven cloth as the vamp of a shoe, able to reduce manpower needed for producing shoes formerly, and such woven shoes can be formed integrally and can reduce one third of cloth, tallying to environmental protection and further, such woven shoes are light in weight, high in cladding and comfort in wearing. However, if the woven cloth of woven shoe is to form patterns or grain at outward appearance, special knitting manufacturing method has to be employed for directly forming patterns on the woven cloth, or other articles formed with patterns have to be combined with the woven cloth by machine sewing or sticking, but patterns formed by knitting is high in cost and little in change and further, having patterns combined with the woven cloth through machine sewing or gluing still have shortcomings.

In view of the above-mentioned drawbacks, the inventor of this invention thinks that the conventional method of forming patterns on the woven cloth is necessary to be ameliorated and hence devises this invention.

### SUMMARY OF THE INVENTION

The objective of this invention is to offer a kind of woven cloth and a method able to integrally form a three-dimensional pattern on the woven cloth and its finished product. The woven cloth can be formed integral with a three-dimensional pattern without employing a method of machine sewing or sticking, able to simplify manufacturing process, lower cost, reinforce strength, avoid woven cloth disengaging and breaking apart and further able to be produced fully automatically.

The woven cloth in the present invention is composed of lots of yarns and each yarn is made from several monofilaments, which have their outer circumferences respectively formed with a thermoplastic polymer layer.

The method able to integrally form a three-dimensional pattern on the woven cloth includes the following steps:

A first step is preparation of woven cloth. The woven cloth is composed of lots of yarns and each yarn is made from several monofilaments and further, each monofilament has its outer circumference coated with a thermoplastic polymer layer;

A second step is preparation of a hot compression mold having hot pressing function. The hot compression mold has its inner surface preformed with a protruding three-dimensional pattern;

A third step is hot compression molding. The woven cloth is placed in the hot compression mold to carry out heating and compressing; and

A fourth step is obtaining of a finished product. After the woven cloth is hot compressed, the woven cloth will produce a depressed three-dimensional pattern corresponding to the hot compression mold through the hot compressing or heat melting of the thermoplastic polymer layer.

The woven cloth formed with a three-dimensional pattern of this invention is to make use of the above-mentioned method to have the woven cloth hot compressed in a mold, which is preformed with a three-dimensional pattern, and integrally formed with a three-dimensional pattern through compressing or hot melting of the thermoplastic polymer layer.

The woven cloth and the method able to integrally form a three-dimensional pattern on the woven cloth and its finished product in the present invention is to have the woven cloth made from special yarns placed in a special hot compression mold to be hot compressed and integrally formed, thereon with a three-dimensional pattern, needless to use the method of machine sewing or sticking, able to enhance combination strength, reduce labor and cost and then elevate market competitive force.

### BRIEF DESCRIPTION OF DRAWINGS

This invention will be better understood by referring to the accompanying drawings, wherein:

FIG. 1 is a perspective view of a first preferred embodiment of a kind of woven cloth in the present invention;

FIG. 2 is a partial magnified view of yarns of the first preferred embodiment in the present invention;

FIG. 3 is a perspective view of the woven cloth of the first preferred embodiment after the woven cloth is hot compressed in the present invention;

FIG. 4 is a cross-sectional view of the woven cloth of the first preferred embodiment after the woven cloth is hot compressed in the present invention;

FIG. 5 is a block flowing diagram of the steps of the method for integrally forming a three-dimensional pattern on the woven cloth in the present invention;

FIG. 6 is a schematic view of a hot compression mold for heat compressing the woven cloth in the present invention;

FIG. 7 is a perspective view of a second preferred embodiment of woven cloth after the woven cloth is hot compressed in the present invention;

FIG. 8 is a cross-sectional view of the second preferred embodiment of the woven cloth after the woven cloth is hot compressed in the present invention;

FIG. 9 is a cross-sectional view of a third preferred embodiment of the woven cloth after the woven cloth is hot compressed in the present invention;

FIG. 10 is a perspective view of a fourth preferred embodiment of the woven cloth after the woven cloth is hot compressed in the present invention;

FIG. 11 is a cross-sectional view of the fourth preferred embodiment of the woven cloth after the woven cloth is hot compressed in the present invention; and

FIG. 12 is a schematic view of the woven cloth formed with three-dimensional patterns in the present invention and applied to the vamp of a shoe.

### DETAILED OF THE PREFERRED EMBODIMENT

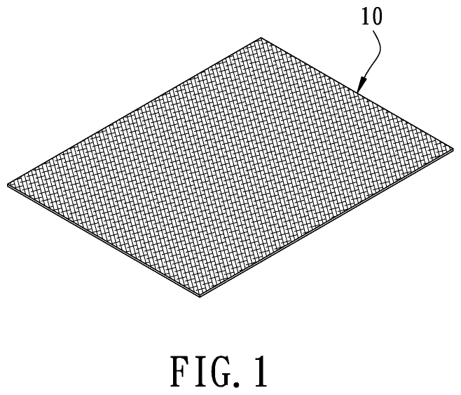

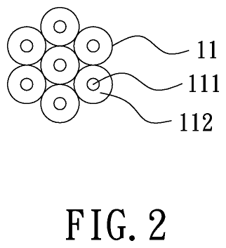

A preferred embodiment of a kind of woven cloth 10 in the present invention, as shown in FIGS. 1-4, is composed of lots of yarns 11 and each yarn 11 is made from several monofilaments 111 and each monofilament 111 has its outer circumference formed with a thermoplastic polymer layer 112. In this preferred embodiment, the thermoplastic polymer layer 112 is thermoplastic polyurethan and thus, after the woven cloth 10 is hot compressed by a mold, which is preset with a pattern, the woven cloth 10 will be integrally formed with a corresponding three-dimensional pattern through compressing and hot melting of the thermoplastic polymer layer 112.

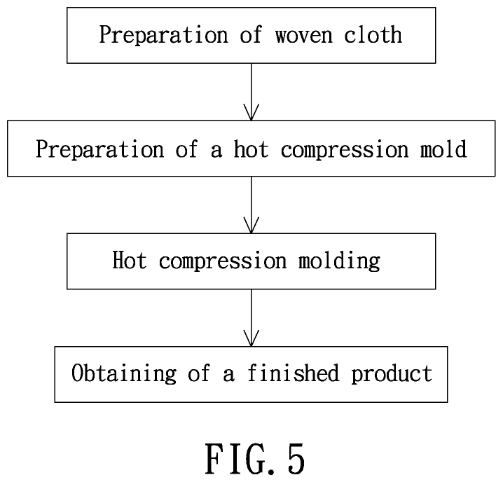

A method able to integrally form a three-dimensional pattern on the woven cloth, as shown in FIG. 5, includes the following steps:

A first step is preparation of woven cloth 10. The woven cloth 10 is the composed of lots of yarns 11 and each yarn 11 is made from several monofilaments 111 and further, each monofilament 111 has its outer circumference coated with the thermoplastic polymer layer 112, which is thermoplastic polyurethan;

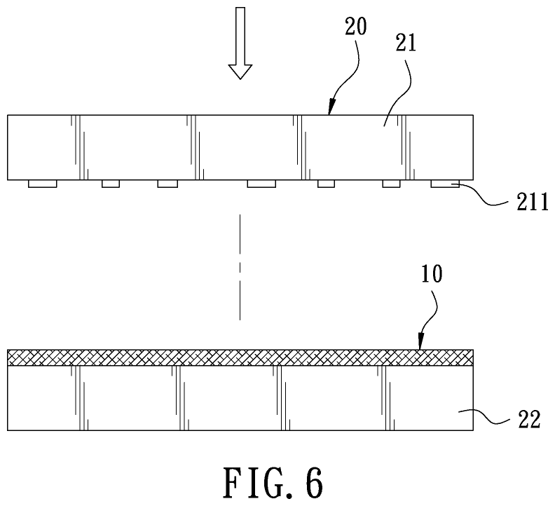

A second step is preparation of a hot compression mold 20. The hot compression mold 20, as shown in FIG. 6, has heat pressing function and consists of an upper mold 21 and a lower mold 22. The upper mold 21 has its inner surface preformed with protruding three-dimensional patterns 211. In this preferred embodiment, the height of the three-dimensional pattern 211 is smaller than the thickness of the woven cloth 10;

A third step is hot compression molding. The woven cloth 10 is placed in the hot compression mold 20 to be heated and compressed; and

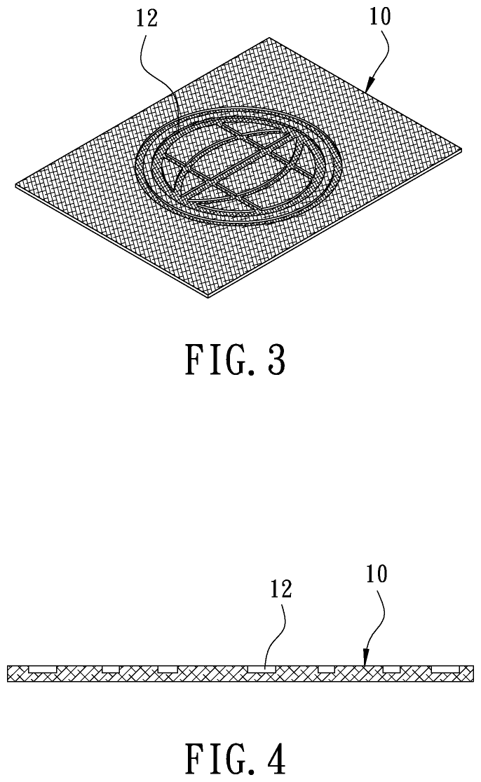

A fourth step is obtaining of a finished product. Referring to FIGS. 3 and 4, after hot compression molding, the woven cloth 10 will produce a depressed three-dimensional pattern 12 corresponding to the protruding three-dimensional pattern 211 of the hot compression mold 20 through heat pressing and hot melting of the thermoplastic polymer, but the three-dimensional pattern 12 does not penetrate through the woven cloth 10.

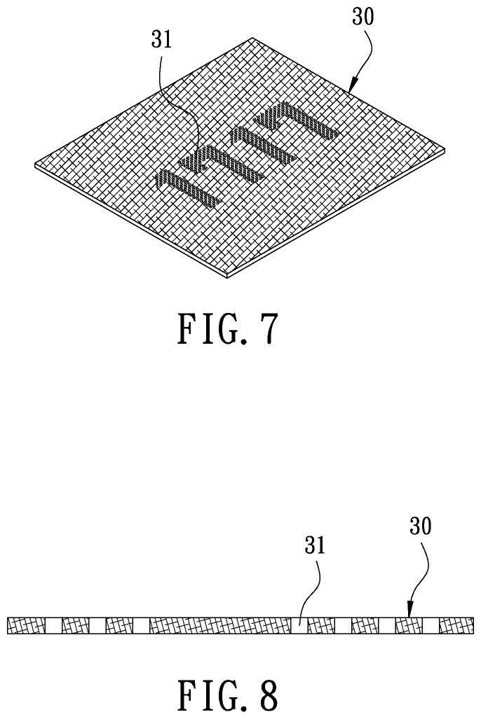

A second preferred embodiment of a method able to integrally form a three-dimensional pattern on the woven cloth in the present invention, as shown in FIGS. 7 and 8, is to have the inner surface of the hot compression mold 20 preformed with a three-dimensional pattern 211, and the height of this three-dimensional pattern 211 is greater than the thickness of the woven cloth 30. Thus, after the woven cloth 30 is hot compressed through hot compressing and hot melting of the thermoplastic polymer, the woven cloth 30 will produce a three-dimensional pattern 31 corresponding to the three-dimensional pattern 211 of the hot compression mold 20, and the three-dimensional pattern 31 penetrates through the woven cloth 30. Since the three-dimensional pattern 31 can imitate the weaving pattern of general woven cloth; therefore, the woven cloth 30 has weaving effect.

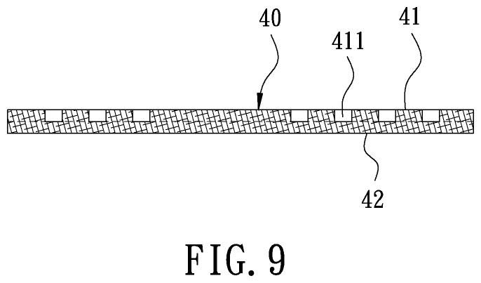

A third preferred embodiment of a method able to integrally form a three-dimensional pattern on the woven cloth in the present invention, as shown in FIG. 9, is to have the woven cloth 40 composed of two kinds of different-colored yarns and make the woven cloth 40 formed with a surface layer 41 and a bottom layer 42, the surface layer 41 positioned on the bottom layer 42. Since the surface layer 41 and the bottom layer 42 are woven with different-colored yarns; therefore, the surface and the bottom of the woven cloth 40 are formed with different colors. Thus, when the height of the three-dimensional pattern 211 preformed at the inner surface of the hot compression mold 20 is approximately equal to the thickness of the surface layer 41 of the woven cloth 40, after the woven cloth 40 is hot compressed, the surface layer 41 of the woven cloth 40 will form a three-dimensional pattern 411 penetrating through the surface layer 41 by hot compressing of the thermoplastic polymer. Thus, the color of the bottom layer 42 of the woven cloth 40 can be exposed to the surface layer 41 via the three-dimensional pattern 411, letting the three-dimensional pattern 411 produce bicolor effect.

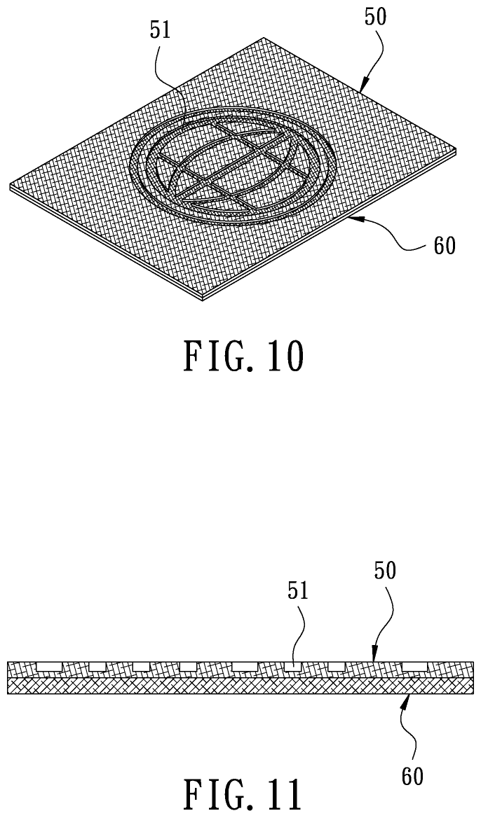

A fourth preferred embodiment of a method able to integrally form a three-dimensional pattern on the woven cloth in the present invention, as shown in FIGS. 10 and 11, is to prepare two pieces of woven cloth 50, 60 in the first step and then, have the woven cloth 50, 60 overlapped on each other and placed in the hot compression mold 20 to carry out heating and compressing. After the woven cloth 50 is hot compressed through hot compressing and hot melting of the thermoplastic polymer, the upper woven cloth 50 will form a depressed three-dimensional pattern 51 corresponding to the hot compression mold 20 and simultaneously, the upper woven cloth 50 and the lower woven cloth 60 will be fused and fixed together due to compressing and hot melting of the location of the depressed three-dimensional pattern 51.

What is worth mentioning is that after the woven cloth 10 of this invention is hot compressed, the woven cloth 10 will be hardened because of hot melting of the thermoplastic polymer, able to enhance hardness of the woven cloth 10. Therefore, the woven cloth 10 can present different hardness through hot pressing of the hot compression mold 20.

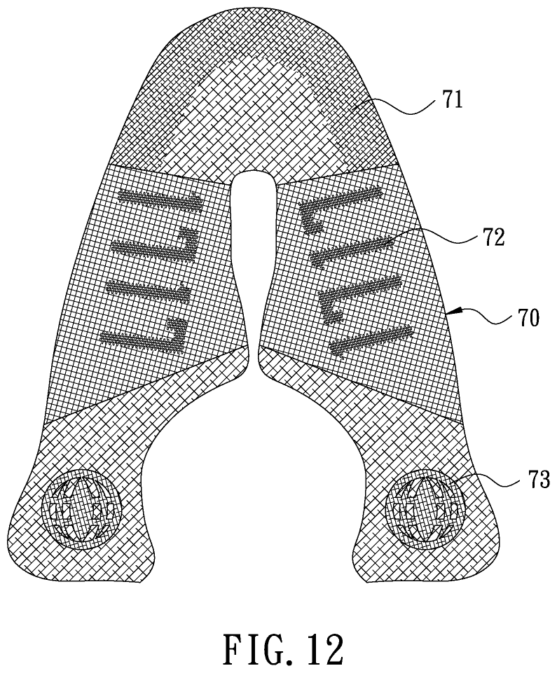

FIG. 12 shows that this invention can be applied to the vamp 70 of a shoe. The vamp 70 is made by using the finished product of various kinds of woven cloth formed with different three-dimensional patterns of this invention. The vamp 70 can form various effects according to the needs of different parts. For instance, to be used for the front section of the vamp 70, which needs to increase hardness, double-layer woven cloth is hot compressed in the hot compression mold 20 to be combined to form a reinforced part 71, and to be used for the middle section of the vamp 70, the woven cloth is hot compressed by the hot compression mold 20 to form a first three-dimensional pattern 72 penetrating through the woven cloth, and for the rear section of the vamp 70, the double-layer woven cloth is hot compressed by the hot compression mold 20 to form a depressed second three-dimensional pattern 73 and make the double-layer woven cloth combined and fixed together. Therefore, the same woven cloth of this invention can be formed thereon with various effects through hot compressing once by the hot compression mold 20 in accordance with needs, or integrally formed with height different patterns or integrally formed with penetrating patterns and further formed with various kinds of hardness. Obviously, the invention can be applied extensively and can attain many different effects.

The special feature of this invention is that the woven cloth of this invention can be integrally formed with a three-dimensional pattern through hot compressing of a hot compression mold, needless to use the method of machine sewing or sticking. Therefore, this invention not only can save time and labor and lower manufacturing cost, but also can cope with the coming of industry 4.0 without need of manpower to be a participant of full automation.

To sum up, the same woven cloth of this invention can be integrally formed with various weaving effects, or integrally formed with height difference patterns, or integrally formed with penetrating patterns and further can form various hardness through hot pressing of the hot compression mold; therefore, this invention is really extensive in application, able to attain various effects.

While the preferred embodiments of the invention have been described above, it will be recognized and understood that various modifications may be made therein and the appended claims are intended to cover all such modifications that may fall within the spirit and scope of the invention.

What is claimed is:

1. A kind of woven cloth, said woven cloth composed of lots of yarns, each said yarn made from several monofilaments, each said monofilament having an outer circumference formed with a thermoplastic polymer layer.

2. The woven cloth as claimed in claim 1, wherein said thermoplastic polymer is thermoplastic polyurethan.

3. The woven cloth as claimed in claim 1, wherein said yarn is composed of two different-colored yarns, said woven cloth formed with a surface layer and a bottom layer, said surface layer and said bottom layer made from different-colored yarns and formed with different colors.

4. A method able to integrally form a three-dimensional pattern on the woven cloth comprising the following steps:
a first step: preparation of woven cloth: said woven cloth composed of lots of yarns, each said yarn made from several monofilaments, each said monofilament having an outer circumference formed with a thermoplastic polymer layer;
a second step: preparation of a hot compression mold: said mold having hot pressing function, said mold having an inner surface preformed with a protruding three-dimensional pattern;
a third step: hot compression molding: said woven cloth placed in said hot compression mold to be heated and compressed; and
a fourth step: obtaining of a finished product: said woven cloth removed out of said hot compression mold, said woven cloth formed with a depressed three-dimensional pattern corresponding to said hot compression mold through hot pressing or hot melting of said thermoplastic polymer.

5. The method able to integrally form a three-dimensional pattern on the woven cloth as claimed in claim 4, wherein in the first step, said woven cloth is composed of two kinds of yarns with different colors, said woven cloth formed with a surface layer and a bottom layer made from different-colored yarns.

6. The method able to integrally form a three-dimensional pattern on the woven cloth as claimed in claim 4, wherein in the first step, two pieces of woven cloth are prepared, in the third step, said two piece of woven cloth overlapped each other and placed in said hot compression mold to be heated and compressed.

7. The method able to integrally form a three-dimensional pattern on the woven cloth as claimed in claim 4, wherein in the first step, said thermoplastic polymer is formed at an outer circumference of said monofilament in a way of costing.

8. A kind of woven cloth formed with a three-dimensional pattern is to make use of the method stated in claim 4 to have said woven cloth hot compressed by a mold that is preset with a three-dimensional pattern, said woven cloth able to be integrally formed with a three-dimensional pattern through compressing and hot melting of said thermoplastic polymer layer.

9. The woven cloth formed with a three-dimensional pattern as claimed in claim 8, wherein said three-dimensional pattern is a depressed pattern formed at a topside of said woven cloth.

10. The woven cloth formed with a three-dimensional pattern as claimed in claim 8, wherein said three-dimensional pattern is a pattern penetrating through said woven cloth.

11. The woven cloth formed with a three-dimensional pattern as claimed in claim 6, wherein said two pieces of woven cloth are hot compressed by a mold that is preset with a three-dimensional pattern to have the upper said woven cloth formed with a depressed three-dimensional pattern through compressing or hot melting of said thermoplastic polymer layer, the upper woven cloth and the bottom woven cloth fused and fixed together through compressing and hot melting of said three-dimensional pattern.
